(19) United States
(12) Patent Application Publication
(10) Pub. No.: US 2003/0195792 A1
(43) Pub. Date: Oct. 16, 2003

(54) Method of animal feed market analysis

(75) Inventors: Valerie Thompson, Circle Pines, MN (US); Mike Craig, Monticello, MN (US); David A. Cook, Coon Rapids, MN (US)

Correspondence Address: Scott T. Piering, Law Department, Cargill, Inc., P.O. Box 5624, Minneapolis, MN, 55440-5624, US

(73) Assignee: Cargill, Inc.

(21) Appl. No.: 10/122,283

(22) Filed: Apr. 12, 2002

(51) Int. Cl. G06F 17/60

(52) U.S. Cl. 705/10

(57) ABSTRACT

A valuation method for determining the impact of a modification in the nutrient composition of an ingredient or the impact of a new ingredient on the value of the ingredient and the value of competing ingredients. The method can include utilizing a repository of information related to potential markets that is incorporated in the evaluation to provide a valuation. This method allows analysis of multiple formulations of animal feed utilizing the new or modified ingredient in a designated market to determine projected usage and value.

### FIELD OF THE INVENTION

The present invention relates generally to the field of market analysis methods. More particularly, the present invention relates to methods for evaluating the impact of a modification in the nutrient composition of an ingredient or the impact of a new ingredient on the value of the ingredient and the value of competing ingredients in an animal feed market.

### BACKGROUND OF THE INVENTION

In general, animal feed products are compositions of a large variety of raw materials or ingredients. The ingredients can be selected using two criteria. This first criteria is the nutritional composition of the ingredient. The second criteria is the cost of the ingredient.

The nutritional composition of a feed ingredient can be used in combination with the nutritional composition of every other ingredient in the feed to produce an animal feed that optimizes the growth and production of the animal and/or economic return. Animal feed producers have recognized that certain nutritional compositions help animals to grow larger faster than if they used other nutritional compositions. Additionally, animal feed producers have recognized that high amounts of certain nutrients can actually impede the growth rate of an animal. Further, animal feed producers have recognized that optimal nutritional composition changes depending on the developmental stage of the animal in question (e.g. newborn, weaning, gestating). The ideal nutrient composition can also change based on additional factors, including the health of the animal and whether the animal is nursing. Therefore, animal feed producers have recognized that by mixing ingredients to produce an ideal nutritional composition for particular animals at particular growth stages, they can maximize the growth of an animal.

The second criteria for selecting animal feed ingredients is the cost of the ingredients. Although one ingredient may have an ideal or better nutritional profile, if it can be replaced by lower cost ingredients, it may be desirable to use the lower cost ingredients. Cost of ingredients and growth maximization are balanced against each other. For example, where a high growth rate for a particular animal is not economically advantageous because of, for example, seasonal markets or quantity demand, an animal producer may elect to use a less costly feed that does not produce the same growth rate.

Raw ingredient producers can attempt to maximize the nutritional composition of their product for the lowest cost. Raw ingredient producers often maximize the nutritional composition of the ingredient by either producing a new ingredient or improving the nutritional composition of an existing ingredient. In determining what to research and produce, raw ingredient producers evaluate the value of the new ingredient or the ingredient with an improved nutritional composition. There is no easy method for predicting value of new ingredients because they are new.

Thus, there is a need for a method that can help predict the value of a new ingredient or an ingredient with a modified nutritional composition. Further, there is a need for such a method that can help predict the effect of the new ingredient or ingredient with a modified nutritional composition on the value of existing ingredients in an animal feed market.

### SUMMARY OF THE INVENTION

An exemplary embodiment is related to an animal feed market analysis method for evaluating the impact of a new ingredient or an ingredient that has a modified nutrient composition on the economic value of the ingredient and the economic value of existing ingredients that could substitute for the new or modified ingredient. This method can include receiving a nutrient profile for the new or modified ingredient, predicting projected economic value of the new or modified ingredient.

Another exemplary embodiment is related to a method of enabling access to an animal market feed analysis system. This method can include using a first processing system to maintain an animal feed market information processing unit that receives and processes requests for valuation of a new or modified animal feed ingredient, receiving a signal for invoking the animal feed market information processing unit for a remote processing system via a network where the signal is transmitted from the remote processing system in response to a selection of a hypermedia link, and using the first processing system to operate the animal feed market information processing unit in response to the signal.

Another exemplary embodiment is related to a method of determining the economic value of a new ingredient or an ingredient with a modified nutrient composition. This method can include receiving a nutrient profile for a new or modified ingredient from an input device, accessing animal feed market conditions, determining an economic value for the new or modified ingredient.

Other principle features and advantages of the invention will become apparent to those skilled in the art upon review of the following drawings, the detailed description, and the appended claims.

### BRIEF DESCRIPTION OF THE DRAWINGS

The exemplary embodiments will hereafter be described with reference to the accompanying drawings, wherein like numerals denote like elements, and:

FIG. 1A is a flow diagram illustrating a method for evaluating the impact of a modification in a nutrient composition of an ingredient or the impact of a new ingredient on the value of the ingredient and the value of competing ingredients in accordance with an exemplary embodiment;

FIG. 1B is a map depicting regional market designations based on concentrations of types of animals in accordance with an exemplary embodiment;

FIG. 2 is a general block diagram illustrating a data repository in accordance with an exemplary embodiment;

FIG. 3 is a flow diagram illustrating steps in calculating the impact of a modification in the nutrient composition of an ingredient or the impact of a new ingredient on the value of the ingredient and the value of competing ingredients in accordance with an exemplary embodiment;

FIG. 4 is a general block diagram illustrating a stand alone computing system in accordance with an exemplary embodiment;

FIG. 5 is a general block diagram illustrating computers operating in a network environment in accordance with an exemplary embodiment; and

FIG. 6 is a web page in accordance with yet another exemplary embodiment.

### DETAILED DESCRIPTION OF EXEMPLARY EMBODIMENTS

A method of evaluating the impact of a new ingredient or a modification in the nutrient composition of an ingredient on the value of the ingredient and the value of competing ingredients are described. In the following description, for the purposes of explanation, numerous specific details are set forth in order to provide a thorough understanding of the present invention. It will be evident, however, to one skilled in the art that the exemplary embodiments may be practiced without these specific details. In other instances, structures and devices are shown in diagram form in order to facilitate description of the exemplary embodiments.

In at least one exemplary embodiment illustrated below, a computer system is described which has a central processing unit (CPU) that executes sequences of instructions contained in a memory. More specifically, execution of the sequences of instructions causes the CPU to perform steps, which are described below. The instructions may be loaded into a random access memory (RAM) for execution by the CPU from a read-only memory (ROM), a mass storage device, or some other persistent storage. In other embodiments, hardwired circuitry may be used in place of, or in combination with, software instructions to implement the functions described. Thus, the embodiments described herein are not limited to any particular source for the instructions executed by the computer system.

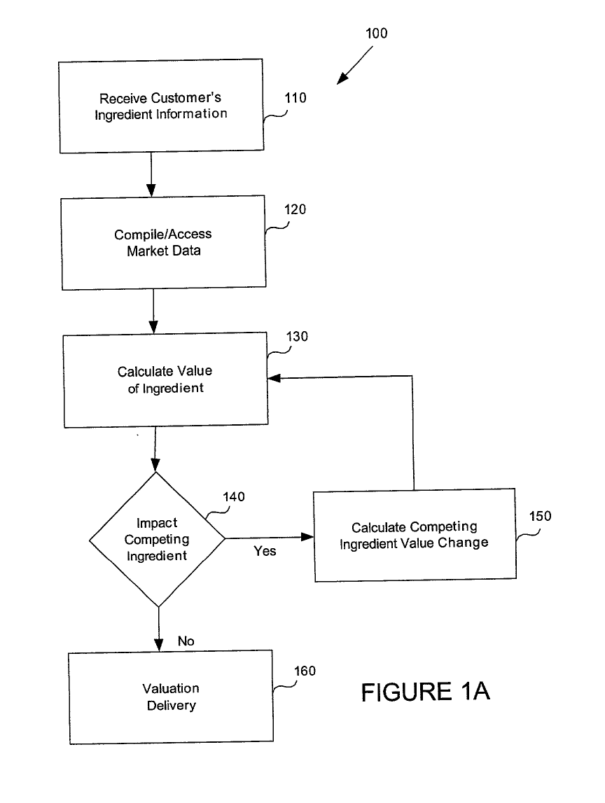

FIG. 1A illustrates a flow diagram 100 depicting steps in a method for evaluating the impact of a modification in a nutrient composition of an ingredient or the impact of a new ingredient on the value of the ingredient and the value of competing ingredients. A new ingredient can be a new composition of matter that has nutritive properties that can be used in animal feed. A modified ingredient can be an existing ingredient with some aspect of its nutrient profile modified. A competing ingredient can be an ingredient that can be used as a substitute for the new or modified ingredient, either singly or in combination with other competing ingredients.

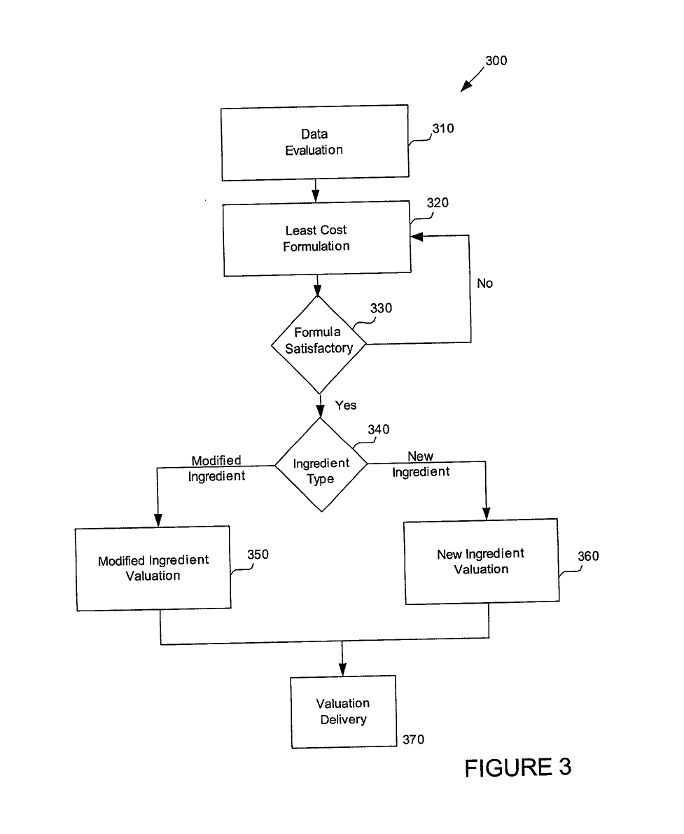

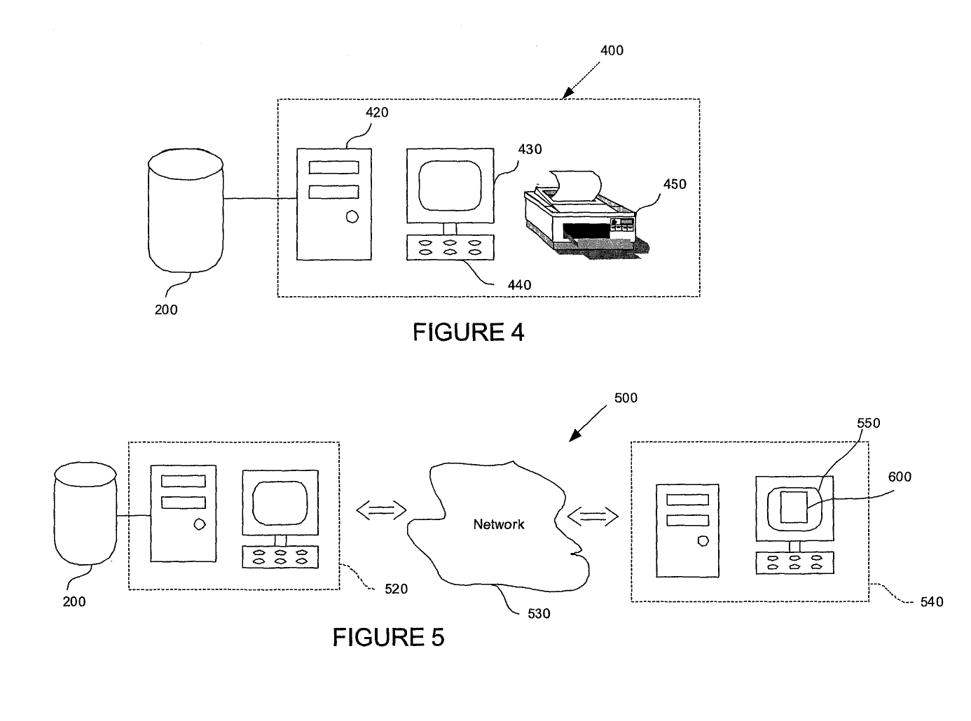

According to an exemplary embodiment, in a step 110, customer ingredient information is received. According to one embodiments a human operator performs the method and facilitates information transfers and information gathering. According to this exemplary embodiment, information can be received by the operator through a person to person communication, either direct or indirect. According to an alternative embodiment, customer ingredient information can be received by a stand alone computer system using any type of input device such as a keyboard, a mouse, a voice recognition system, etc. An exemplary stand alone computer system is described with reference to FIG. 4. According to an additional alternative embodiment, customer ingredient information can be received by a computer operating in a network environment. An exemplary network embodiment is described with reference to FIG. 5.

The customer ingredient information conveyed by the customer can include a nutrient composition for the new or modified ingredient, a potential market for the new or modified ingredient, and a type of animal targeted to be fed by the new or modified ingredient. The nutrient composition of the new or modified ingredient generally can include physical and chemical properties, such as, mineral content, vitamin content, particle size, fiber content, etc.

A potential market can include a specific geographic area, such as a state or a region, a trade organization, such as a commodities market, or any other type of market. The potential market can be a customer definition of the desired market, a customer selection from a finite number of defined markets, or any other method wherein the customer indicates the market to be examined based on any of a variety of criteria.

FIG. 1B illustrates a market designation map 180 of the United States including a finite set of markets established based upon concentrations of specific types of animals. Market designation 181 encompasses a geographical area wherein there may be a high concentration of swine producers. Market designation 182 encompasses a geographical area wherein there may be a high concentration of bovine producers. The type of animal targeted to be fed by the new or modified ingredient can be any type of animal, including cows, pigs, turkeys, fish, etc.

Returning to FIG. 1A, following step 110, a step 120 is performed in which data can be retrieved. The data can be retrieved from a data repository or obtained from any other source. According to an exemplary embodiment, an operator can retrieve the data by referencing the data repository or by using other sources of information. The other sources of information can include, but is not limited to, newspapers, the Internet, market reports, trade journals, etc.

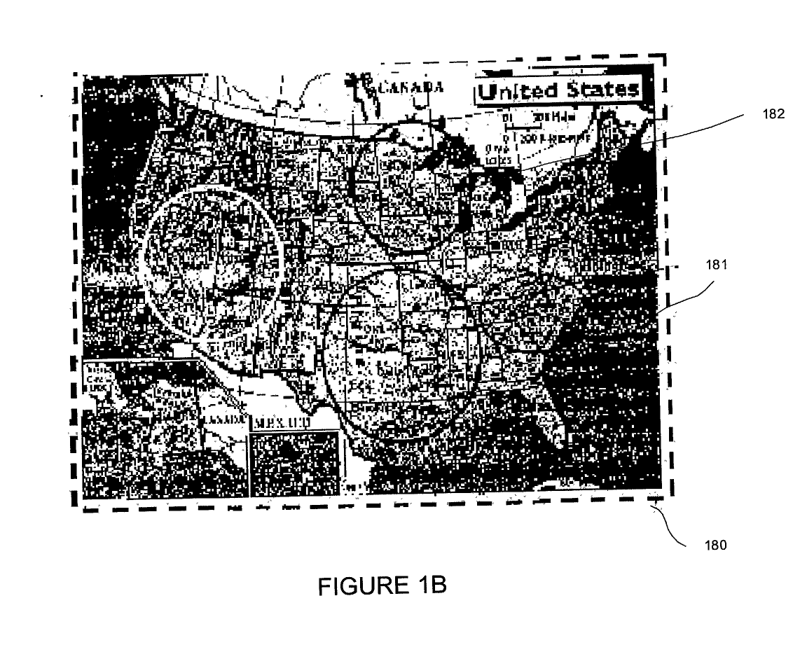

An example of a data repository is described further with reference to FIG. 2. Generally, the type of data stored on the repository can be any information necessary or useful in predicting the impact of a new ingredient or a modification in the nutrient composition of an ingredient on the value of the ingredient and the value of competing ingredients.

Data stored in the data repository can be archived values based upon a study performed yearly. An example of this type of data can be projected animal populations within a given region. Alternatively, the data repository can be used to access data that updates daily, hourly, or even continuously. An example of this type of data can be the prices for competing ingredients. This data can be continuously updated using a polling method or an Internet link to a price indicator in a commodity market as examples.

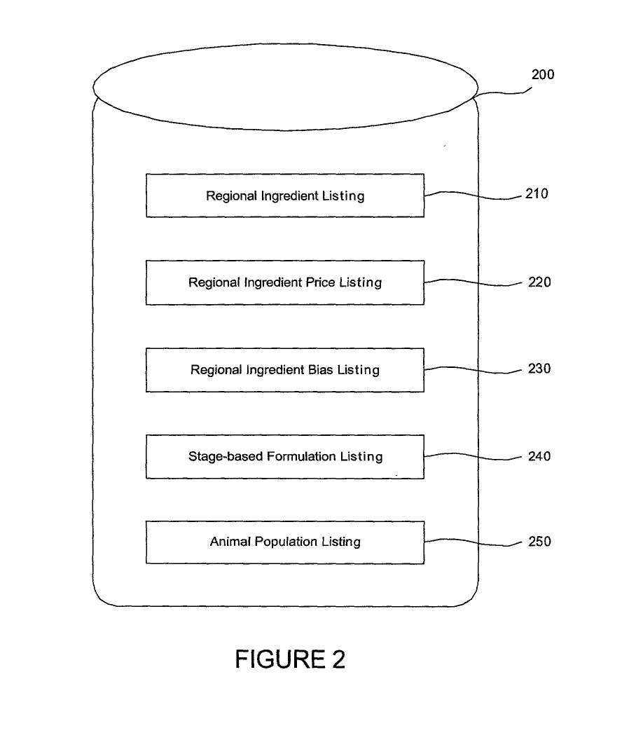

After step 120, a step 130 can be performed in which a value is determined for the new or modified ingredient. An exemplary value determination is described with reference to FIG. 3. Generally, the determination can be performed to predict the new value or change in value of a new or modified ingredient based on the inputs given as described above.

After step 130, a determination can be made in a step 140 whether the value or change in value of the new or modified ingredient has an effect on the value of competing ingredients. This determination can be based on a number of factors. The factors can include the projected market penetration for the new or modified ingredient, the output production capability for the new or modified ingredient, etc.

If a determination is made in step 140 that the value or change in value of the new or modified ingredient has an effect on the value of competing ingredients, a step 150 can be performed wherein a new predicted value for competing ingredients is calculated. Following this calculation, step 130 can be repeated using the new values for the competing ingredients. This loop condition, including steps 130, 140 and 150, can be repeated until a stable system is established. A stable system is established when ingredient prices within the method will not change in reaction to other ingredient prices.

If a determination is made in step 140 that the value or change in value of the new or modified ingredient does not have an effect on the value of competing ingredients, a step 160 can be performed in which an analysis of the value of the new or modified ingredient is delivered. The analysis can be as simplistic or complex as required by the customer. An example of a simplistic analysis can be a simple price value at which value will be maximized. An example of a complex analysis can include prices at which value is maximized at varying levels of production, prices at which the value of competing ingredients will not be affected, etc.

Advantageously, the ingredient valuation method, described with reference to FIG. 1A can be offered as a service to ingredient producers, researchers, or others. Alternatively, the method can be used as an internal evaluation tool. Customers, external or internal, can be ingredient producers that are considering production of a new ingredient or an ingredient with a modified nutrient composition. Customers may also be researchers that are considering development of a new ingredient or a method to improve the nutrient composition of an existing ingredient. Potential customers can be any person with a need to know the impact of a modification in the nutrient composition of an ingredient or the impact of a new ingredient on the value of the ingredient and the value of competing ingredients.

FIG. 2 illustrates a data repository 200 that can be used to store information that can be used in determining the value of a new or modified ingredient. Generally, information in data repository 200 is related to potential markets in which a customer may be intending to sell the new or modified ingredient. Data repository 200 can be a computer including memory, a database, a computer file, a paper file, or any other device or apparatus capable of facilitating storage and retrieval of data.

According to an exemplary embodiment, data repository 200 can include a variety of files, such as regional ingredient file 210, a regional ingredient price file 220, a regional ingredient bias file 230, a stage-based formulation file 240, and an animal population file 250. Other data that may affect the valuation can also be included or reflected in the above mentioned categories of information.

Regional ingredient file 210 can be a record of ingredients currently or projected to be available in a region. Example ingredients include corn, wheat, wheat midds, lysine, HCL, and high protein soy meal. This information can be obtained using market reports, expert input, or any other source. According to an exemplary embodiment, the region for a particular entry in regional ingredient file 210 can be designated by the customer or chosen from a predefined listing. Regional ingredient file 210 can be an archived file created and stored in data repository 200. This file can be updated as necessary to reflect current or projected conditions in the market. According to a preferred embodiment, regional ingredient file 210 can also include a nutrient composition for the ingredients available in the region. The nutrient composition can include physical and chemical properties, such as, mineral content, vitamin content, particle size, fiber content, etc.

Regional ingredient price file 220 can be a file of the prices of the ingredients in regional ingredient file 210. The prices can be the price of the delivered ingredient. Advantageously, using the delivered price accounts for transportation costs. Prices can include historical, current, and projected values. Historical price information can be obtained from existing records. Current prices can be obtained from any listing, such as, the newspaper, a web listing, or any other source reporting the current price of ingredients. Projected values can be obtained by extrapolating from historical prices based on any relevant current conditions. Regional ingredient price file 220 can be an archived file stored in data repository 200. Alternatively, regional ingredient price file 220 can be a link to information reflecting the most current ingredient prices. This link may be provided by telephone, a newspaper, the Internet, or any other means. Advantageously, storing and allowing retrieval of a variety of pricing information allows the customer to predict a value using the information that is most suitable to meet their needs.

Regional ingredient bias file 230 can be a listing of weights to be given to ingredient in calculating projected use. According to an exemplary embodiment, the weighting can include a minimum value for the amount of an ingredient that is used in a region. An example of weights can be that a thousand metric tons of corn is used in an upper Iowa region regardless of any cost inefficiencies. Advantageously, regional ingredient bias file 230 accounts for a regional bias in which market participants tend to use a given ingredient at a level that is not economically optimal. This value can be created using analysis of past market trends, expert predictions, or any other method. Regional ingredient bias file 230 can be stored values in a file within data repository 200.

Stage-based nutrient requirement file 240 can be a file of the nutrient requirements for different types of animals at various stages of development and health. Examples of stages of development and health can include newborn, weaning, young, maturing, gestating, or any other differentiation that can reflect different nutrient requirements. Generally, the nutrient requirements for a newborn animal or a gestating animal are significantly different from the requirements for a healthy adult animal. For example, a gestating animal may need a formulation that includes a high concentration of calcium to promote development of the fetus.

According to a preferred embodiment, stage-based nutrient requirement file 240 can also include the volume of feed consumed by an animal at a given stage. This value can be obtained based on historical record or expert testimony. An example can be that gestating pigs consume 150 pounds of feed per month. Advantageously, examining the nutrient requirements at various stages for various animals allows for a more precise calculation of the projected demand for specific ingredients. Stage-based nutrient requirement file 240 can be an archived file stored in data repository 200.

Animal population file 250 can be a listing of the animal populations in a region. Examples can include the number of swine, the number of cows, etc. Animal population file 250 can also be divided into subgroups based on the stage of development of the animals in the population as discussed above in reference to stage-based nutrient requirement file 250.

According to an exemplary embodiment, animal population file 250 can also include historical, current and projected values. The historical and current values can be obtained from any source such as a regional department of agriculture report. The projected population can be extrapolated from the historical values based on current conditions.

Animal population file 250 can also incorporate a market penetration concept, such that only a subset of the total animal population is used in calculating demand based on anticipated market penetration. According to an exemplary embodiment, a subset of the animal population may be fed using only locally grown ingredients. Accordingly, the locally fed subset would be excluded in calculating projected demand.

Advantageously, analysis of stage-based nutrient requirement file 240 and animal population file 250 allows for calculation of the projected demand for ingredients based on the nutrient requirements for the animal population within a given region. This calculation can be performed using the formulation methods described below in reference to FIG. 3.

FIG. 3 illustrates a flow chart 300 of steps in a method of calculating the value of a new or modified ingredient. In a step 310, data gathered on customer ingredients can be evaluated. One example of gathering ingredient information is described with reference to steps 110 and 120 in FIG. 1A. The data is evaluated to detect any aberrations or departures from the normal that would skew a valuation analysis. This analysis can be performed with a linear regression analysis or similar method. Any aberrant values can be reexamined or discarded from the sample set.

After step 310, a step 320 can be performed in which information from a memory storage device and information received from the customer are used as inputs to a least cost formulation system. A least cost formulation system determines an ideal mix of ingredients, including the new or modified ingredient, that satisfies a set of nutrient requirements for the lowest possible cost. The set of nutrient requirements is the nutrient requirement for a specific animal at a specific stage of development, as described above in reference to FIG. 2. Least cost formulation systems are well known to those of skill in the art. The least cost formulation can be performed for each of the stages of development of the animal targeted. Advantageously, completing formulations for each of the stage of development of the animal target allows for a more complete prediction of demand.

After step 320, a determination can be made in a step 330 to determine whether the formulation satisfies feasibility and wholesomeness requirements. If the formulation is not satisfactory, step 320 can be repeated including additional constraints to improve wholesomeness or feasibility as needed.

Following the determination in step 330 that the formulation is satisfactory, a determination can be made in a step 340 whether the ingredient to be examined is an existing ingredient with a modified nutrient composition or a new ingredient.

If the ingredient to be examined is determined in step 340 to be an existing ingredient with an improved nutrient composition, a step 350 can be performed. In step 350, the ideal formulations calculated in step 320 can be analyzed in a least cost formulation system. The least cost formulation system calculates ideal feed mix for a variety of formulations based upon market constraints such as production costs, speed of production, ingredient availability, etc. An example of a least cost formulation system is Multi-Mix sold by Format International, Limited, Woking, England. Advantageously, use of a least cost formulation analysis allows evaluation of the modified ingredient in several formulations to be performed simultaneously. In step 350, projected usage rates for all of the ingredients used an inputs to the calculation can be provided.

If the ingredient to be examined is determined in step 340 to be a new ingredient, a step 360 can be performed. In step 360, a least cost formulation analysis can be performed using the ideal formulations calculated in step 320 and including only commodities specific to the region. Following this analysis, an additional least cost formualtion analysis can be performed using the ideal formulations calculated in step 320 and including the new ingredient in addition to commodities specific to the region. For this analysis, the new ingredient can be assigned the same price as an existing ingredient with a similar nutrient composition. Advantageously, this step provides a realistic starting valuation for a new ingredient. In step 360, projected usage rates for all of the ingredients used an inputs to the calculation can be provided.

Following the least cost formulation analysis in steps 350 and 360 of the two ingredient sets, a parametric analysis can be performed on the output from the two least cost formulation analyses to predict optimal prices for the new ingredient. A parametric analysis is an examination of the data sets to determine prices above which usage rates drop dramatically. For example, the usage rate may slowly decrease until a price of $2.00/pound, but at $2.25/pound, the usage rate decreases dramatically as users switched to a cheaper alternative. The optimal price may therefore be $2.00/pound. The optimal price is then used as the new ingredient price in a final least cost formulation calculation.

Following step 350 or 360, a step 370 can be performed in which the usage rates calculated in the least cost formulation operations are used to calculate the total value created by the introduction of the new or modified ingredient. According to an exemplary embodiment, the calculations can be used to generate an output spreadsheet. The output spreadsheet can be used to show the volume of the new or modified ingredient used within the least cost formulation system along with the premium received above the compared commodity.

FIG. 4 illustrates a standalone computer system 400 that can be used to evaluate the impact of a modification in the nutrient composition of an ingredient or the impact of a new ingredient on the value of the ingredient and the value of competing ingredients. Computer system 400 can include a processor 420, a visual display unit 430, an input device 440, and an output device 450. Standalone computer system 400 can further be associated with a memory storage unit such as data repository 200, described with reference to FIG. 2, such that computer system 400 can access data stored within data repository 200.

Computer system 400 can be any type of computing device, including work stations, laptops, notebooks, personal digital assistants (PDAs), or other equipment capable of receiving input from input device 440, accessing data repository 200, executing a series of instructions and providing an output to visual display unit 430 or output device 450. Processor 420 can be any type of processor capable of executing instructions, such as an Intel® Pentium® processor. Visual display unit 430 can be any type of visual display, such as a CRT tube monitor or an LCD display screen. Input device 440 can be a keyboard, a touchpad, voice recognition, file transfer, or any other method or apparatus for communicating information to standalone computing system 400. Output device 450 can be a laser printer, a dot matrix printer, an email program, or any other method or apparatus of communicating information from standalone computing system 400.

According to an exemplary embodiment, a customer seeking a value analysis for a new or modified ingredient can utilize the methods described with reference to FIGS. 1-3 using computer system 400. The customer can use input means 440 to provide necessary inputs. Computing system 400 can be used to implement an ingredient valuation system in which processor 420 can receive the inputs, access data repository 200 for additional required information, and perform necessary calculations. The results of the analysis can be provided alternatively on visual display unit 430 or output device 450.

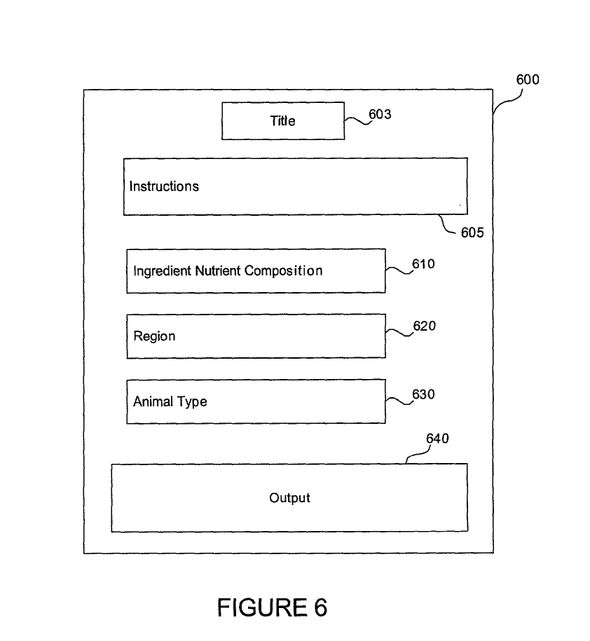

FIG. 5 illustrates a feed market analysis system 500 to evaluate the impact of a modification in the nutrient composition of an ingredient or the impact of a new ingredient on the value of the ingredient and the value of competing ingredients. System 500 can include a first computing system 520, a computer network 530, and a second computing system 540. Second computing system 540 further includes a web browsing application 550 capable of displaying a web page 600 provided by first computing system 520, described with reference to FIG. 6.

First computing system 520 and second computing system 540 can be any type of computer system, such as standalone computing system 400, discussed in reference to FIG. 4. Computing system 520 and second computing system 540 further include devices for communicating over network 530. Additionally, first computing system 520 further can be associated with data repository 200 such that first computing system 520 can access data stored within data repository 200.

According to an exemplary embodiment, network 530 is the Internet, a worldwide network of computer networks that use various protocols to facilitate data transmission and exchange. Network 530 can use a protocol, such as the TCP/IP network protocol or the DECnet, X.25, and UDP protocols. According to alternative embodiments, network 530 can be any type of network, such as a virtual private network (VPN), an Ethernet, or a Netware network. Further, network 530 can include a configuration, such as, a wide area network (WAN) or a local area network (LAN). Network 530 preferably provides communication with a Hypertext Markup Language (HTML).

Web browsing application 550 can be any type of application capable of accessing information stored on other computing systems over network 530. Examples can include applications such as Internet Explorer® sold by Microsoft Corporation of Redmond, Wash. or Netscape® sold by Netscape Communications Inc. of Mountain View, Calif. According to an exemplary embodiment, web browsing application 550 can be used to access first computing system 520, to receive data, and to display web page 600. An exemplary web page is described with reference to FIG. 6.

According to an exemplary embodiment, a customer seeking to utilize system 500 to evaluate the impact of a modification in the nutrient composition of an ingredient or the impact of a new ingredient on the value of the ingredient and the value of competing ingredients can access second computing system 540 and run web browsing application 550. Web browsing application 550 can be directed to retrieve web page 600 from first computing system 520 over network 530.

Once retrieved, web page 600 can be used by the customer to provide necessary inputs. The necessary input can include customer ingredient input described with reference to FIG. 1A. According to an exemplary embodiment, an exemplary method of providing information through web page 600 is discussed below in reference to FIG. 6. First computing system can receive the inputs and access data repository 200 to gather information necessary to perform the evaluation of value. First computing system 520 can then transfer evaluation results to second computing system 540 over network 530 for display on web page 600.

According to an exemplary embodiment, web page 600 can require satisfaction of a log on procedure prior performing the evaluation and transferring evaluation results. An example of a log on procedure can include provision of a user name and password in designated text entry boxes provided on web page 600 that correspond stored values.

FIG. 6 illustrates a web page 600 of an exemplary embodiment of web page 600. Web page 600 is a visual display of a document written in HyperText Markup Language (HTML) including embedded pictures, links, and data fields. Web page 600 can be a single web page or a series of web pages accessed through embedded links in a first web page. A first web page in a series can include a username and password access control method to provide customer recognition.

According to an exemplary embodiment, web page 600 can include a title 603, an instruction set 605, a new or modified ingredient nutrient composition input field 610, a region input field 620, an animal type input field 630, and an output field 640. Title 603 can be used to identify the page and include proprietary graphics identifying the source of the page. Instruction set 605 can be an information necessary for the customer to utilize the ingredient valuation system and method.

Input fields 610, 620 and 630 can be implemented as text entry fields, selectable drop down menu field, file transfer points, or any other method in which the necessary information would be inserted for transfer to first computing system 520. Output field 640 can be a downloaded file, a spreadsheet embedded object, or any other means in which calculation results transferred from first computing system 520 can be displayed. An example could be a spreadsheet populated with the results of the analysis including graphs, charts, and description to explain the calculation results.

According to an exemplary embodiment, the customer can use web browsing application 550 to access web page 600. Web page 600 can be displayed on the visual display unit for second computing system 540. The customer can read instruction set 605 to understand how to utilize the ingredient valuation method and web page 600. The user can enter data in input fields 610, 620, and 630 with data as described with reference to FIG. 1A. Once the data is entered, the system can process the information using the method described with reference to FIG. 1A. The results of the ingredient valuation method can be returned to the user in output field 640.

While the exemplary embodiments illustrated in the figures and described above are presently preferred, it should be understood that these embodiments are offered by way of example only. Other examples may include, for example, a wide variety of ways to convey information regarding the value of a new or modified ingredient such as, wireless application protocol (WAP), personal digital assistant (PDA) protocols, and other presentation means. Further, while exemplary embodiments describe the invention in the context of animal feed markets, the invention may extend to other ingredient markets which are components to a formulation. Additionally, specific information is described above as coming from specific sources for use in the system and method, but any information that is relevant, from any source, can be used in the calculations. The invention is not limited to a particular embodiment, but extends to various modifications, combinations, and permutations that nevertheless fall within the scope and spirit of the appended claims.

What is claimed is:

1. An animal feed market analysis method for evaluating the impact of a new ingredient or an ingredient that has a modified nutrient composition on the economic value of the new or modified ingredient and the economic value of existing ingredients that could substitute for the new or modified ingredient, the method comprising:
receiving a nutrient profile for the new or modified ingredient; and
predicting a projected economic value of the new or modified ingredient.

2. The method of claim 1, wherein predicting an economic value for the new or modified ingredient includes predicting a projected usage for the new or modified ingredient.

3. The method of claim 2, wherein predicting an economic value for the new or modified ingredient includes predicting the market effect of the projected usage through which usage rates for the existing ingredients may change.

4. The method of claim 2, wherein predicting projected usage for the new or modified ingredient includes using the new or modified ingredient as an input in a least cost formulation system, wherein the least cost formulation system calculates mixtures of ingredients given as inputs based on user defined constraints such as price and minimum nutrient requirements.

5. The method of claim 4, wherein the least cost formulation system uses an initial projected price for the cost of the new or modified ingredient based on the price of comparable ingredients.

6. The method of claim 4, wherein the least cost formulation system uses only ingredients for sale in a customer designated market as inputs in the least cost formulation system.

7. The method of claim 4, wherein the least cost formulation system analysis is performed using the new or modified ingredient for every feed formulation found in a region, wherein a feed formulation is a mixture of specific amounts of ingredients.

8. The method of claim 4, wherein the every feed formulation includes different formulations for different species of animals.

9. The method of claim 4, wherein the every feed formulation includes different formulations for different stages of development for a specific animal.

10. The method of claim 4, wherein predicting projected usage of the new or modified ingredient using a least cost formulation system includes determining ingredients displaced by the projected usage of the new or modified ingredient.

11. The method of claim 4, wherein predicting projected usage of the new or modified ingredient using a formulation system includes calculating projected volume demand for the new or modified ingredient.

12. The method of claim 11, wherein calculating projected volume demand includes analyzing regional animal populations to determination of the number of animals in each population.

13. The method of claim 12, wherein analyzing regional animal populations includes a determination of the stage of development of the animals in populations.

14. The method of claim 12, wherein analyzing regional animal populations includes a determination of projected intake of various formulations for the animal population.

15. The method of claim 3, wherein predicting the market effect of the projected usage for the new or modified ingredient includes evaluating existing animal feed market conditions based on historical, current, and projected conditions.

16. The method of claim 3, wherein predicting the market effect of the projected usage for the new or modified ingredient includes analyzing regional ingredient pricing and availability.

17. The method of claim 3, wherein predicting the market effect of the projected usage for the new or modified ingredient includes an analysis of regional biases for each existing ingredient.

18. The method of claim 3, wherein predicting the market effect of the projected usage for the new or modified ingredient includes calculating probable changes in the price of existing ingredients based on the introduction of the new or modified ingredient.

19. The method of claim 18, wherein determining the economic value of the new or modified ingredient includes recalculating the projected usage for the new or modified ingredient based on changes in the price of existing ingredients.

20. The method of claim 3, wherein predicting the market effect of the projected usage for the new or modified ingredient includes calculating market penetration.

21. The method of claim 2, wherein determining the economic value of the new or modified ingredient is calculated based on the economic value of ingredients that were displaced during the least cost formulation.

22. A method of providing access to an animal market feed analysis system, the method comprising:
using a first processing system to maintain an animal feed market information processing unit, the animal feed market information processing unit receiving and processing requests for valuation of a new or modified animal feed ingredient;
receiving a signal requesting the animal feed market information from a remote processing system via a network, the signal having been transmitted from the remote processing system in response to a selection of a hypermedia link; and
using the first processing system to operate the animal feed market information processing unit in response to the signal.

23. The method of claim 22, wherein receiving a signal requesting the animal feed market information includes a log on procedure to restrict access.

24. A method of determining the economic value of a new ingredient or an ingredient that has a modified nutrient composition, the method comprising the steps of:
obtaining a nutrient profile for the new or modified ingredient;
researching animal feed market conditions; and
predicting an economic value for the new or modified ingredient.

25. The method of claim 24, wherein predicting the economic value includes determining projected demand for the new or modified ingredient using an animal feed formulation system.

26. The method of claim 24, wherein predicting the economic value includes determining prices for existing animal feed ingredients.

27. The method of claim 24, wherein access to the method is controlled using a log on procedure.

28. The method of claim 24, wherein receiving the nutrient profile for the new or modified ingredient includes a communication with an operator.

29. The method of claim 24, wherein receiving the nutrient profile for the new or modified ingredient includes a communication with a computer.
